(19) United States
(12) Patent Application Publication
(10) Pub. No.: US 2012/0230718 A1
(43) Pub. Date: Sep. 13, 2012

(54) FIXING DEVICE AND IMAGE FORMING APPARATUS

(75) Inventors: Yuki KUBOTA, Kanagawa (JP); Tahei Nakamura, Kanagawa (JP); Yasutaka Gotoh, Kanagawa (JP); Koji Okabe, Kanagawa (JP)

(73) Assignee: FUJI XEROX CO., LTD., Tokyo (JP)

(21) Appl. No.: 13/217,802

(22) Filed: Aug. 25, 2011

(30) Foreign Application Priority Data
Mar. 10, 2011 (JP) 2011-053085

(51) Int. Cl. G03G 15/20

(52) U.S. Cl. 399/69; 399/122; 399/329

(57) ABSTRACT

A fixing device includes a heat fixing member including a base body that is elastically deformable and applies heat to a medium; a press fixing member that applies pressure to the medium, a contact moving member that moves at least one of the heat fixing member and the press fixing member between a pressurizing position and a depressurizing position; a temperature detector disposed so as to face a position between an intersection of a first imaginary line and an outer surface of the heat fixing member and an intersection of a second imaginary line and the outer surface, the first imaginary line connecting a center of a fixing region and a rotation center of the heat fixing member, the second imaginary line passing through the rotation center and being perpendicular to the first imaginary line; and a temperature controller that controls a temperature of the heat fixing member.

### CROSS-REFERENCE TO RELATED APPLICATIONS

This application is based on and claims priority under 35 USC 119 from Japanese Patent Application No. 2011-053085 filed Mar. 10, 2011.

### BACKGROUND

### Technical Field

The present invention relates to a fixing device and an image forming apparatus.

### SUMMARY

According to an aspect of the invention, a fixing device that fixes an unfixed image transferred to a surface of a medium includes a heat fixing member that is supported so as to be rotatable and contactable with the surface of the medium, the heat fixing member being heated by a heater, the heat fixing member including a base body that is elastically deformable and that has a cylindrical shape extending in a medium width direction that intersects a transport direction of the medium, the base body applying pressure to the medium and increasing a contact area between the base body and the medium by being elastically deformed without using a member that is disposed so as to contact an inner surface of the cylindrical shape in a fixing region, and applying heat to the medium when the base body is rotated and passes the fixing region, the fixing region being a region in which the base body contacts the medium, the base body elastically recovering to the cylindrical shape when the base body has passed the fixing region after being rotated; a press fixing member that is disposed so as to face the heat fixing member and that is supported so as to be rotatable, the press fixing member applying pressure to the medium that is nipped between the press fixing member and the heat fixing member; a contact moving member that moves at least one of the heat fixing member and the press fixing member between a pressurizing position and a depressurizing position, the pressurizing position being a position at which the heat fixing member and the press fixing member contact each other with a predetermined contact pressure in the fixing region in which the heat fixing member and the press fixing member contact each other, the depressurizing position being a position at which the heat fixing member and the press fixing member are separated from each other as compared with the pressurizing position and pressure in the fixing region is reduced from the predetermined contact pressure; a temperature detector that detects a temperature of the heat fixing member, the temperature detector being disposed so as to face a middle position between a first position and a second position in a circumferential direction of the heat fixing member, the first position being an intersection of an extension line of a first imaginary line and an outer surface of the heat fixing member, the first imaginary line being a line connecting a center of the fixing region and a rotation center of the heat fixing member, the fixing region being a region in which the heat fixing member and the press fixing member contact each other, the second position being an intersection of a second imaginary line and the outer surface of the heat fixing member, the second imaginary line being a line that passes through the rotation center of the heat fixing member and that is perpendicular to the first imaginary line; and a temperature controller that controls operation of the heater on the basis of a detection result obtained by the temperature detector and thereby controls a temperature of the heat fixing member.

### BRIEF DESCRIPTION OF THE DRAWINGS

Exemplary embodiments of the present invention will be described in detail based on the following figures, wherein:

FIG. 1 is a perspective view of an image forming apparatus according to a first exemplary embodiment of the present invention;

FIG. 2 is an overall view of the image forming apparatus according to a first exemplary embodiment of the present invention;

FIG. 3 is an enlarged sectional view of the fixing device according to the first exemplary embodiment;

FIG. 4 is a sectional view of the fixing device taken along line IV-IV of FIG. 3;

FIGS. 5A and 5B illustrate the fixing device according to the first exemplary embodiment, FIG. 5A illustrating a state in which a pressing belt and the heating roller are at a pressurizing position at which fixing is performed, and

FIG. 5B illustrating a state in which the pressing belt and the heating roller are at a depressurizing position at which the pressing belt is separated from the heating roller;

FIGS. 6A and 6B illustrate a contact moving member of the fixing device according to the first exemplary embodiment, FIG. 6A illustrating a perspective view of the contact moving member, and FIG. 6B illustrating a sectional view of the contact moving member taken along line VIB-VIB of FIG. 6A;

FIG. 7 is a partial sectional view of the heating roller according to the first exemplary embodiment;

FIGS. 8A and 8B illustrate a known structure, FIG. 8A illustrating a case where a heating roller that is a thin-wall cylinder is used and a temperature sensor is disposed on a side of the heating roller opposite to a fixing region, and FIG. 8B illustrating a case where a heating roller that is a thick-wall cylinder is used;

FIG. 9 illustrates an operation of the first exemplary embodiment when tips are arranged along the short axis; and

FIG. 10 is a partial enlarged view of a fixing device of according to a second exemplary embodiment, which corresponds to FIG. 7 for the first exemplary embodiment.

### DETAILED DESCRIPTION

Hereinafter, exemplary embodiments of the invention will be described with reference to the drawings. The present invention is not limited to the exemplary embodiments.

For ease of understanding, the front-back direction, the left-right direction, and the up-down direction in the figures are respectively defined as the X-axis direction, Y-axis direction, and the Z-axis direction. The directions indicated by arrows X, −X, Y, −Y, Z, and −Z will be respectively referred to as forward, backward, rightward, leftward, upward, and downward, or the front side, the back side, the right side, the left side, the top side, and the bottom side.

In each figure, a small circle with a dot in it indicates an arrow that is oriented from the back surface toward the front surface of the plane of the figure, and a small circle with a cross in it indicates an arrow that is oriented from the front surface toward the back surface of the plane of the figure.

For ease of understanding, members that are not necessary for the following description are not illustrated in the figures.

### First Embodiment

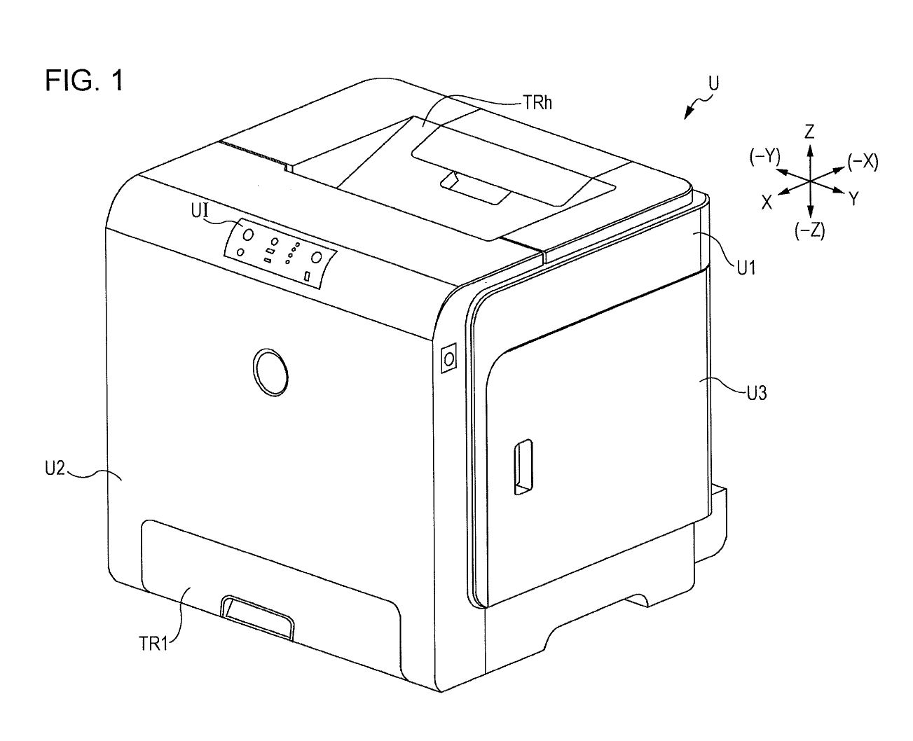

FIG. 1 is a perspective view of a printer U, which is an example of an image forming apparatus according to a first exemplary embodiment of the present invention.

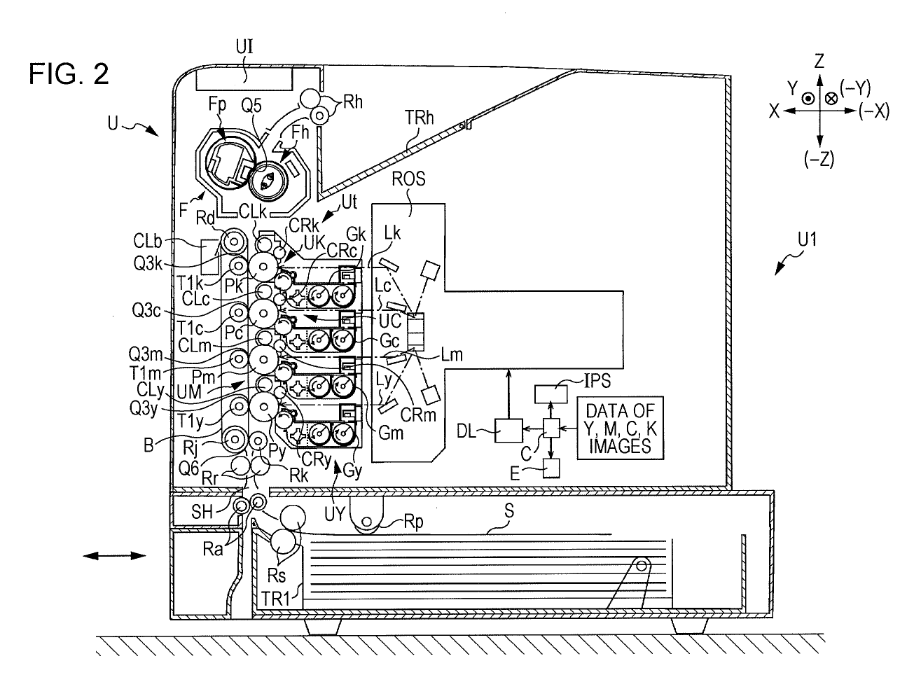

FIG. 2 is an overall view of the printer U.

Referring to FIGS. 1 and 2, a sheet feed tray TR1 is disposed in a lower part of the printer U, and a sheet S, which is an example of a medium for recording an image thereon, is contained in the sheet feed tray TR1. A sheet output tray TRh is disposed on the upper surface of the printer U. An operation panel UI, which has input buttons etc., is disposed on an upper part of the printer U.

The printer U according to the first exemplary embodiment includes an apparatus body U1, a front cover U2, and a side cover U3. The front cover U2, which is an example of an openable/closable member, is disposed on a front surface of the apparatus body U1. The side cover U3, which is an example of an openable/closable member, is disposed on a side surface of the apparatus body U1. A user opens the front cover U2 and accesses the inside of the apparatus body U1 to replace an image carrier cartridge, a developing device, or a defective component; clean the inside of the apparatus body U1; or remove a jammed sheet S. A user opens the side cover U3 to replace a toner cartridge, which is an example of a developer container.

Referring to FIG. 2, the printer U includes a controller C that controls the operations of the printer U, an image processor IPS that is controlled by the controller C, a writing control circuit DL, and a power supply E. The power supply E applies voltages to charge rollers Cry to CRk, which will be described below and which are examples of a charger; a developing roller, which is an example of a developer carrier; and transfer rollers T1y to T1k, which are examples of a transfer device.

The image processor IPS receives print data from a personal computer or the like, which is an example of an external image data transmitter, converts the print data into color image data for forming each of black (K), yellow (Y), magenta (M), and cyan (C) latent images, and outputs the color image data to the writing control circuit DL at a predetermined timing. The writing control circuit DL outputs a driving signal to a latent image forming device ROS in accordance with the color image data. The latent image forming device ROS outputs laser beams Ly, Lm, Lc, and Lk, which are examples of a writing beam for each color, in accordance with the driving signal.

Referring to FIG. 2, visible image forming units UY, UM, UC, and UK are disposed in front of the latent image forming device ROS. The visible image forming units UY, UM, UC, and UK respectively form toner images, which are examples of yellow (Y), magenta (M), cyan (C), and black (K) visible images.

The visible image forming unit UK, which forms a black (K) visible image, includes a photoconductor Pk, which is an example of a rotatable image carrier. A charging roller CRk, a developing device Gk, a photoconductor cleaner CLk, etc., are arranged around the photoconductor Pk. The charging roller CRk is an example of a charger. The developing device Gk develops an electrostatic latent image on the photoconductor surface into a visible image. The photoconductor cleaner CLk, which is an example of an image carrier cleaner, removes developer that remains on a surface of the photoconductor Pk.

The charging roller CRk charges the surface of the photoconductor Pk in a charging region in which the charging roller CRk faces the photoconductor Pk. Then, the laser beam Lk writes an electrostatic latent image on the photoconductor Pk in a latent image forming region. The developing device Gk develops the electrostatic latent image into a visible image in a developing region in which the developing device Gk faces the photoconductor Pk.

The black visible image forming unit UK according to the first exemplary embodiment includes an image carrier cartridge and a developer cartridge. The image carrier cartridge is replaceable and includes the photoconductor Pk, the charger CRk, and the photoconductor cleaner CLk, which are integrated with each other. The developer cartridge is replaceable and includes the developing device Gk.

As with the black visible image forming unit UK, the visible image forming units UY, UM, and UC each include an image carrier cartridge and a developer cartridge, which are removable from the apparatus body U1. In the first exemplary embodiment, the four visible image forming units UY to UK are supported by a removable (replaceable) frame Ut. Thus, the four visible image forming units UY to UK may be simultaneously removed from the apparatus body U1 and replaced.

Referring to FIG. 2, a belt module BM is disposed in front of the photoconductors Py to Pk. The belt module BM, which is an example of a recording media transport device, is supported by the front cover U2. The belt module BM includes a transfer/transport belt B, which is an example of a recording medium transport member. The transfer/transport belt B is rotatably supported by a belt driving roller Rd, which is an example of a drive member, and a driven roller Rj, which is an example of a driven member. The belt driving roller Rd and the driven roller Rj constitute a belt support roller (Rd+Rj), which is an example of a holding/transporting member support system according to the first exemplary embodiment.

Transfer rollers T1y, T1m, T1c, and T1k, which are examples of a transfer member, are disposed inside the loop of the transfer/transport belt B so as to face the photoconductors Py to Pk, respectively. A belt cleaner CLb is disposed near an upper part of the transfer/transport belt B. The belt cleaner CLb, which is an example of a transport member cleaner, cleans the transfer/transport belt B. An attraction roller Rk is disposed near a lower part of the transfer/transport belt B. The attraction roller Rk, which is an example of a medium attraction member, is disposed so as to face the driven roller Rj and attracts a sheet S to the transfer/transport belt B. The attraction roller Rk may be omitted.

A feed tray TR1 is disposed below the transfer/transport belt B. The feed tray TR1, which is an example of a recording medium container, contains sheets S, which are examples of a recording medium. A pick-up roller Rp, which is an example of a pick-up member, picks up the sheets S from the feed tray TR1. Separation roller Rs, which are examples of a separation member, separates the sheets S one by one. The sheet S, which has been separated by the separation roller Rs, is transported by a medium transport roller Ra, which is an example of a medium transport member and is disposed on a medium transport path SH, to registration rollers Rr, which are examples of a feed timing adjustment member. The registration roller Rr transports the sheet S to a recording medium attraction position Q6, at which the driven roller Rj and the medium attraction roller Rk face each other. The sheet S, which has been transported to the recording medium attraction position Q6, is electrostatically attracted to the transfer/transport belt B.

The sheet S, which has been attracted to the transfer/transport belt B, passes the transfer regions Q3y, Q3m, Q3c, and Q3k, in which the transfer/transport belt B faces and contacts the photoconductors Py to Pk, respectively.

The transfer rollers T1y, T1m, T1c, and T1k are disposed inside the loop of the transfer/transport belt B at the transfer region Q3y, Q3m, Q3c, and Q3k. The power circuit E, which is controlled by the controller C, applies transfer voltages, which have a polarity opposite to that of toner, to the transfer rollers T1y, T1m, T1c, and T1k at predetermined timings.

When forming a multicolor image, the transfer rollers T1y, T1m, T1c, and T1k respectively transfer the toner images from the photoconductors Py to Pk to the sheet S, which is held on the transfer/transport belt B. When forming a single-color (monochrome) image, only a black (K) toner image is formed on the photoconductor Pk, and the transfer roller T1k transfers the black toner image to the sheet S.

The photoconductor cleaners CLy to CLk clean the photoconductors Py to Pk by removing toner that remains on the photoconductors Py to Pk after the toner images have been transferred, and the charging rollers CRy to CRk charge the photoconductors Py to Pk again.

The sheet S, to which the toner images have been transferred, is subjected to a fixing operation in a fixing region Q5. The fixing region Q5, which is an example of a fixing position, is a region in which a heating roller Fh of a fixing device F, which is an example of a heat fixing member and a cylindrical rotatable member, contacts a pressing belt Fp, which is an example of a press fixing member. The sheet S, on which the toner images have been fixed, is output to the sheet output tray TRh, which is an example of an output unit, via an output roller Rh, which is an example of an output member.

The belt cleaner CLb cleans the transfer/transport belt B from which the sheet S has been removed.

The recording medium transport device according to the first exemplary embodiment includes the medium transport path SH; the medium transport roller Ra; the registration roller Rr; the transfer/transport belt B; the heating roller Fh and the pressing belt Fp, which are examples of a medium transport member of the fixing device F; and the output roller Rh.

### Fixing Unit

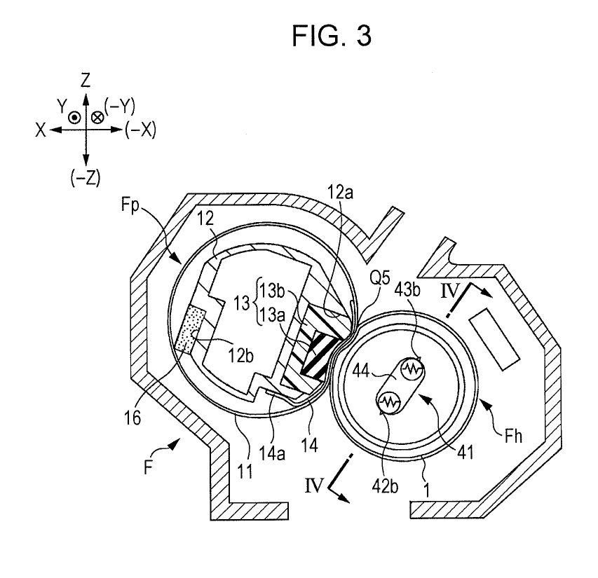

FIG. 3 is an enlarged sectional view of the fixing device F according to the first exemplary embodiment.

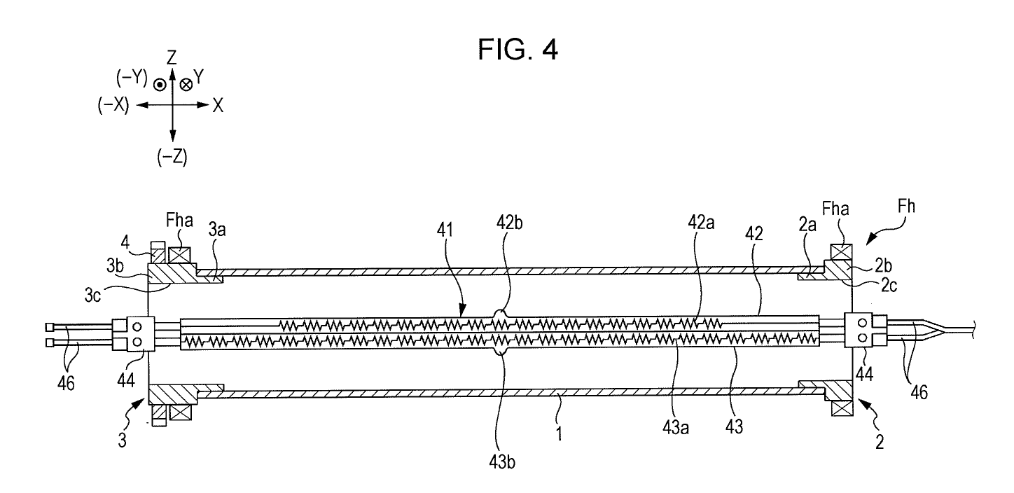

FIG. 4 is a sectional view of the fixing device F taken along line IV-IV of FIG. 3.

### Heating Roller

Referring to FIGS. 3 and 4, in the fixing device F according to the first exemplary embodiment, the heating roller Fh includes a base body 1, which is a thin-wall metal cylinder extending in the left-right direction. The base body 1 according to the first exemplary embodiment is a cylinder that is made of a nickel steel and that has an outer diameter of 25 mm and a thickness of 0.1 mm. The base body 1 is elastically deformable and capable of maintaining the cylindrical shape due to the rigidity thereof. Therefore, when the base body 1 contacts the pressing belt Fp, the base body 1 is elastically deformed, so that the area of a contact region (a so-called “nip region”), which is an example of a contact portion extending in the medium transport direction, is increased. Moreover, the base body 1 applies a pressure due to an elastic force thereof to a part of the medium in the nip region. When the base body 1 is not in contact with the pressing belt Fp, the base body 1 recovers to its original cylindrical shape due to the rigidity thereof.

That is, the base body 1 of the heating roller Fh according to the first exemplary embodiment is different from an endless member such as a belt, which is incapable of maintaining a cylindrical shape due to the rigidity thereof. Moreover, the base body 1 does not include a pressing member (so-called “support member”) that deforms the base body 1 into a predetermined shape, such as a planer shape, in the fixing region Q5, or applies a predetermined contact pressure to the base body 1.

The base body 1 according to the first exemplary embodiment may be configured such that 4×10⁻³<t/D<8×10⁻³, where t is the thickness of the base body 1 and D is the diameter of the base body when the base body 1 is not elastically deformed; the base body 1 has a Young's modulus that is equal to or higher than 100 GPa and lower than 250 GPa; and the contact pressure is equal to or higher than 0.1 MPa and lower than 0.8 MPa.

As long as the base body 1 is configured as described above, the thickness of the base body 1, for example, is not limited to 0.1 mm and may changed within the range described above. For example, the thickness may be equal to or smaller than 0.15 mm. This is smaller than 0.16 mm, which is the smallest thickness of a generally-used heating roller. The thickness may be in the range of 0.07 mm to 0.12 mm. A nickel steel plate having a thickness of 0.1 mm may be made by using an appropriate method, such as electroforming or deep-drawing.

The material of the base body 1 is not limited to a nickel steel. The material may be, for example, a stainless steel (so-called “SUS”), a nickel-cobalt alloy, copper, gold, or a nickel-iron alloy. In the first exemplary embodiment, the base body 1 is not coated. However, in order to increase releasability, a coating layer having a thickness smaller than 100 μm may be formed on the base body 1. The coating layer may be made of a fluorocarbon resin, which has a high releasability. An elastic layer having a thickness in the range of several tens to several hundreds of μm may be disposed between the base body and the coating layer. The elastic layer may be made of a silicone rubber or the like. In the first exemplary embodiment, the contact region is a region in which the heating roller Fh contacts the medium. The contact region is the fixing region Q5 in FIG. 3 and the region R2 in FIG. 4.

Referring to FIG. 4, a pair of retainers 2 and 3, each having a substantially cylindrical shape, are disposed at ends of the base body 1. The retainers 2 and 3 have base body insert portions 2a and 3a and bearing contact portions 2b and 3b, which are respectively integrally formed. The base body insert portions 2a and 3a are cylindrical, located on inner sides of the retainers 2 and 3, and inserted into the base body 1. The bearing contact portions 2b and 3b are cylindrical and located outward from the base body insert portions 2a and 3a. The bearing contact portions 2b and 3b have a thickness larger than that of the base body insert portions 2a and 3a and a diameter larger than that of the base body 1.

Heater pass-through holes 2c and 3c extend through the retainers 2 and 3 in the axial direction. Outer peripheral surfaces of the retainers 2 and 3 are rotatably supported by the bearings Fha. A driving force is transmitted from a driving source (not shown) to a driven gear 4, which is an example of a driven gear, that is supported at the outer end of the retainer 3 on the left side.

### Pressing Belt

Referring to FIG. 3, the pressing belt Fp according to the first exemplary embodiment includes a belt body 11, which is an example of an endless belt-shaped member extending in the left-right direction (the width direction of the sheet S). A holder 12, which is an example of a retainer, is disposed in the belt body 11 so as to extend in the left-right direction. The holder 12 according to the first exemplary embodiment has a hollow shape to achieve weight reduction. A pressing pad containing portion 12a, which is an example of a pressing member holding portion, is formed as a recess in the fixing region Q5 side of the holder 12. A lubrication pad holding portion 12b, which is an example of an application/holding portion, is formed as a recess in a side of the holder 12 opposite to the fixing region Q5 side.

A pressing pad 13, which is an example of a pressing member, is supported in the pressing pad containing portion 12a and extends in the left-right direction. The pressing pad 13 according to the first exemplary embodiment includes a pre-nip member 13a and a peel-off nip member 13b. The pre-nip member 13a, which is an example of an upstream pressing member, is disposed upstream of the fixing region Q5 in the transport direction of the sheet S. The peel-off nip member 13b, which is an example of a downstream pressing member, is disposed downstream of the fixing region Q5 in the transport direction of the sheet S.

The pre-nip member 13a is made of, for example, an elastic material such as a silicone rubber or a fluorocarbon rubber. However, the material is not limited thereto, and any appropriate material may be used. A surface of the pre-nip member 13a on the fixing region Q5 side has a convex shape corresponding to the shape of the outer peripheral surface of the heating roller Fh, so that the width of the fixing region Q5 in the sheet transport direction is increased when the heating roller Fh contacts the pressing belt Fp.

The peel-off nip member 13b is made of a material having a rigidity higher than that of the pre-nip member 13a. Examples of the material include heat-resistant resins such as polyphenylene sulfide (PPS), polyimide resin, polyester, and polyamide; and metal materials such as iron, aluminum, and stainless steel. Therefore, the peel-off nip member 13b according to the first exemplary embodiment deforms the heating roller Fh at a position downstream of the fixing region Q5 in the sheet transport direction, so that the sheet S is naturally peeled off the heating roller Fh when the sheet S exits the fixing region Q5.

A low-friction sheet 14 is disposed between the pre-nip member 13a and the inner peripheral surface of the belt body 11. The low-friction sheet 14, which is an example of a low-friction member, reduces the friction between the belt body 11 and the pre-nip member 13a. An end portion 14a of the low-friction sheet 14 at an upstream end in the sheet transport direction is fixed to and supported by the holder 12.

A lubrication pad 16 is supported in the lubrication pad holding portion 12b. The lubrication pad 16, which is an example of an application member, is impregnated with a lubricant that is to be applied to the inner peripheral surface of the belt body 11. The lubrication pad 16 according to the first exemplary embodiment is made of, for example, a heat-resistant felt. However, the material of the lubrication pad 16 is not limited thereto, and may be any material that is capable of being impregnated with a lubricant and applying the lubricant to the inner peripheral surface of the belt body 11. A known lubricant, such as an amino modified silicone oil having a viscosity of 300 cSt, may be used as the lubricant.

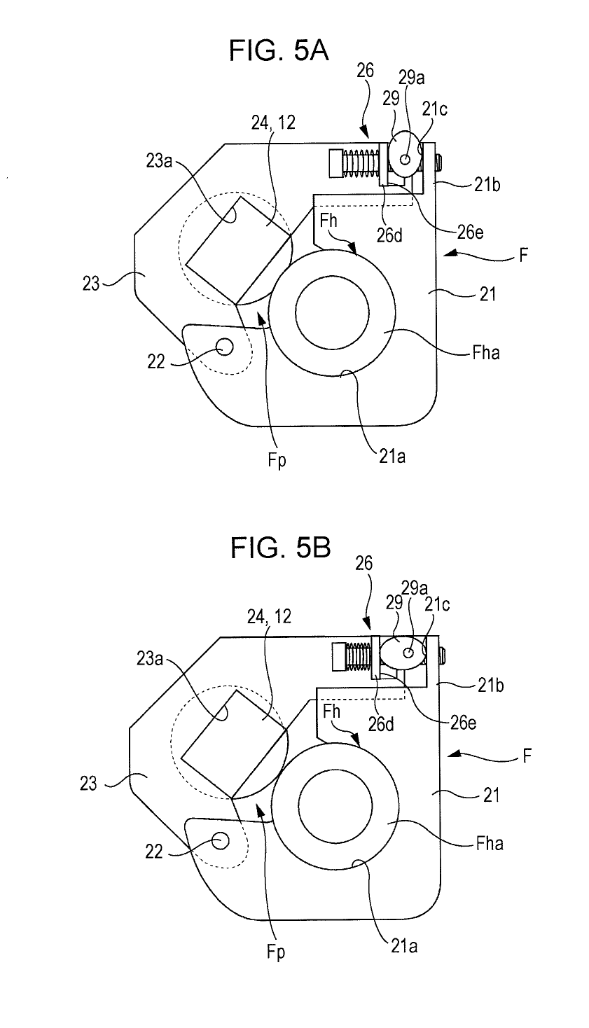

FIGS. 5A and 5B illustrate the fixing device F according to the first exemplary embodiment, FIG. 5A illustrating a state in which the pressing belt Fp and the heating roller Fh are at a pressurizing position at which fixing is performed, and FIG. 5B illustrating a state in which the pressing belt Fp and the heating roller Fh are at a depressurizing position at which the pressing belt Fp is separated from the heating roller Fh.

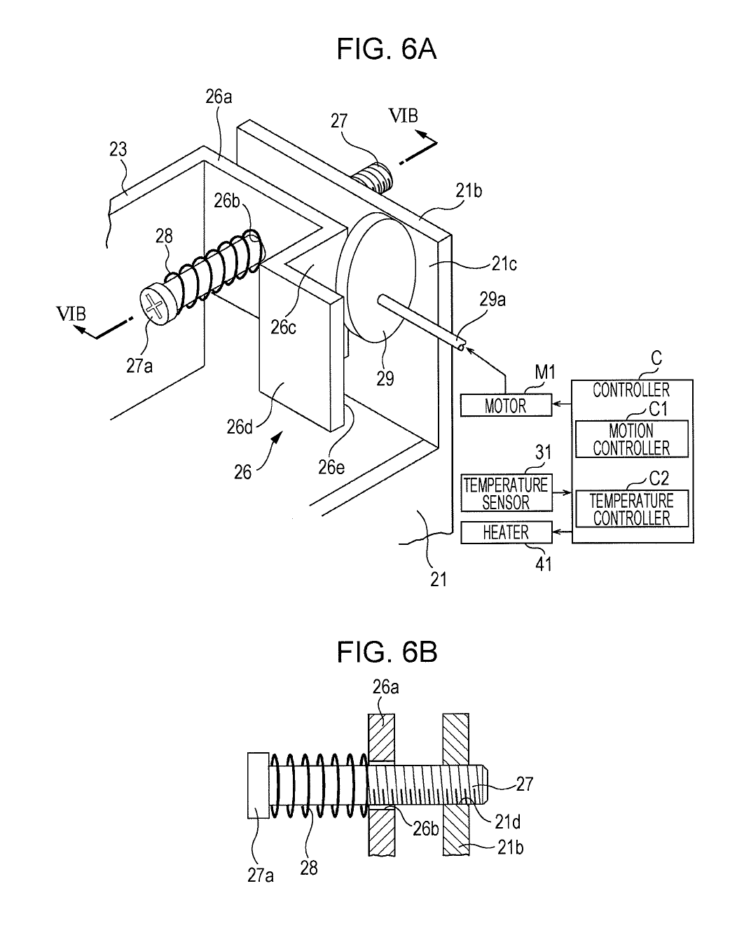

FIGS. 6A and 6B illustrate a contact moving member of the fixing device F according to the first exemplary embodiment, FIG. 6A illustrating a perspective view of the contact moving member, and FIG. 6B illustrating a sectional view the contact moving member taken along line VIB-VIB of FIG. 6A.

Referring to FIGS. 5A to 6B, in the fixing device F according to the first exemplary embodiment, fixed frames 21 are disposed at both ends of the heating roller Fh in the axial direction. The fixed frames 21, which examples of a first frame, support the bearings Fha. The left side portion and the right side portion of the fixing device F are the same except that they are horizontally symmetrical. Therefore, the right side portion in FIGS. 5A to 6B will be described in detail, and detailed description of the left side portion will be omitted.

A bearing groove 21a, which has a U-shape that is open toward the fixing region Q5, is formed in each of the fixed frames 21. The bearing groove 21a supports the bearing Fha of the heating roller Fh. A fixed plate 21b, which is an example of an associatively-driving portion, is formed in an upper rear end part of the fixed frame 21 so as to extend inward in the left-right direction. Referring to FIG. 6A, a cam contacting surface 21c, which is an example of a movement contact portion, is disposed on a front surface of an outer part of the fixed plate 21b in the left-right direction. Referring to FIG. 6B, a screw hole 21d is formed in an inner part of the fixed plate 21b in the left-right direction.

Referring to FIGS. 5A and 5B, a movable frame 23 having a plate-like shape is disposed on an upper front part of the fixed frame 21. The movable frame 23, which is an example of a second frame, is supported so as to be rotatable around a rotary shaft 22 located in a left front part of the fixed frame 21. A bearing groove 23a, which is open toward the fixing region Q5, is formed in the movable frame 23. Receiving portions 24 are fixed to and supported in the bearing groove 23a, and the receiving portions 24 support both ends of the holder 12 of the pressing belt Fp in the left-right direction.

Referring to FIG. 6A, a driven portion 26 is formed in an upper rear part of the movable frame 23. The driven portion 26, which is an example of an associatively-driven portion, extends outward in the left-right direction. The driven portion 26 includes a spring receiving portion 26a having a plate-like shape. The spring receiving portion 26a, which is an example of an urged portion, is disposed at a position corresponding to the screw hole 21d so as to face the fixed plate 21b. Referring to FIG. 6B, a screw pass-through hole 26b is formed in the spring receiving portion 26a at a position corresponding to the screw hole 21d. Referring to FIG. 6A, a connection portion 26c is formed at an outer end of the spring receiving portion 26a in the left-right direction so as to extend forward. At the front end of the connection portion 26c, a cam contact plate 26d, which is an example of a contacted member, is formed so as to extend outward in the left-right direction. On the back surface of the cam contact plate 26d, a cam contacted surface 26e, which is an example of a movable contacted portion, is formed so as to face the cam contacting surface 21c.

Referring to FIGS. 5A to 6B, a screw 27 is supported by the fixed frames 21. The screw 27 extends through the screw pass-through hole 26b and is screwed into the screw hole 21d. A press spring 28, which is an example of an urging member, is disposed between a screw head 27a of the screw 27 and the spring receiving portion 26a of the movable frame 23. The press spring 28 generates a predetermined contact pressure for pressing the pressing belt Fp against the heating roller Fh through the movable frame 23. The press spring 28 according to the first exemplary embodiment is configured such that the pressing belt Fp is pressed against the heating roller Fh with a force in the range of about 100 to 300 N, which corresponds to a pressure of 0.45 MPa per unit area. The pressure may be set in the range of 0.1 to 0.8 MPa by changing the shape or the material of the pressing pad 13.

An eccentric cam 29 having a substantially elliptic shape, which is an example of a contact moving member, is disposed between the cam contacting surface 21c and the cam contacted surface 26e. The eccentric cam 29 is supported so as to be rotatable around a rotary shaft 29a. The eccentric cam 29 rotates when a driving force is transmitted to the rotary shaft 29a from a motor (not shown), which is an example of a driving source.

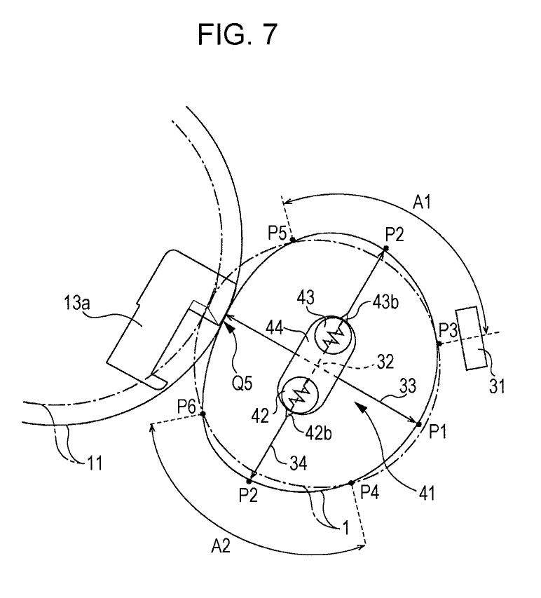

FIG. 7 is a partial sectional view of the heating roller Fh according to the first exemplary embodiment.

When a driving force is transmitted to the eccentric cam 29 from the motor, the eccentric cam 29 moves between a normal position and a heating position. Referring to FIG. 5A, the normal position, which is an example of a first position, is a position at which the short axis of the eccentric cam 29 extends perpendicular to the cam contacting surface 21c and the cam contacted surface 26e. Referring to FIG. 5B, the heating position, which is an example of a second position, is a position at which the long axis of the eccentric cam 29 extends perpendicular to the cam contacting surface 21c and the cam contacted surface 26e. Thus, when the eccentric cam 29 moves to the normal position illustrated in FIG. 5A, the pressing belt Fp moves to a pressurizing position illustrated by a solid line in FIG. 7, at which the pressing belt Fp is pressed against the heating roller Fh by the press spring 28. When the eccentric cam 29 moves to the heating position illustrated in FIG. 5B, the pressing belt Fp moves to a depressurizing position illustrated by an alternate long and short dash line in FIG. 7, at which the press spring 28 is compressed and the pressing belt Fp is separated from the heating roller Fh as compared with the pressuring position and the contact pressure is reduced.

Referring to FIGS. 3 and 7, the fixing device F according to the first exemplary embodiment includes a temperature sensor 31 that is disposed so as to face the heating roller Fh. The temperature sensor 31, which is an example of a temperature detector, detects the temperature of the heating roller Fh. Referring to FIG. 7, a first imaginary line 33 is an imaginary line that connects the center of the fixing region Q5, in which the heating roller Fh and the pressing belt Fp contacts each other, and a rotation center 32 of the cylindrical base body 1 of the heating roller Fh. A second imaginary line 34 is an imaginary line that extends perpendicular to the first imaginary line 33 and that passes through the rotation center 32. A position P1 is an intersection of an extension line of the first imaginary line 33 and the outer surface of the heating roller Fh. A position P2 is an intersection of a second imaginary line and the outer surface of the heating roller Fh. Then, the temperature sensor 31 is disposed so as to face a position P3 that is between a position P1 and a position P2. That is, the temperature sensor 31 is disposed so as to face the position P3, which is an intersection of the outer surface of the heating roller Fh when the heating roller Fh is at the depressurizing position illustrated by the alternate long and short dash line in FIG. 7 and the outer surface of the heating roller Fh when the heating roller Fh is at the pressurizing position illustrated by the solid line in FIG. 7. When the heating roller Fh is at the pressuring position, the outer surface is elastically deformed to a larger extent than when the hating roller Fh is at the depressurized position.

The temperature sensor 31 according to the first exemplary embodiment is disposed at the position P3. However, this is not limited thereto, and the temperature sensor 31 may be disposed at any of positions P4, P5, and P6, which satisfy the same condition as the position P3. When the temperature sensor 31 is disposed at the position P3 or P4, a large space may be used for disposing the temperature sensor 31 so that the temperature sensor 31 may not obstruct the sheet S that passes the fixing region Q5.

In the first exemplary embodiment, a temperature fuse (not shown) is disposed at a position the same as that of the temperature sensor 31 with respect to the circumferential direction of the heating roller Fh and that is displaced from that of the temperature sensor 31 in the axial direction of the heating roller Fh. The temperature fuse, which is an example of a safety device, interrupts flow of an electric current to the fixing device F when the heating roller Fh is overheated.

### Heater

Referring to FIGS. 3, 4, and 7, a heater 41, which is an example of a heater, is disposed in the heating roller Fh. The heater 41 extends through the base body 1 and the heater pass-through holes 2c and 3c in the axial direction.

Referring to FIG. 4, the heater 41 according to the first exemplary embodiment includes a pair of glass tubes 42 and 43. The glass tubes 42 and 43, which are examples of a heater container, extends parallel to each other in the axial direction of the heating roller Fh. The glass tubes 42 and 43 respectively contain heater bodies 42a and 43a, which are examples of a heater body, that generate heat when energized. According to the first exemplary embodiment, the heater body 42a is energized when heating a region corresponding to a width of a small-sized sheet having a width smaller than a predetermined length, which is an example of a small-width medium. The heater body 43a is energized when heating a region corresponding to a width of a large-sized sheet having a width larger than a predetermined length, which is an example of a large-width medium. For example, in the first exemplary embodiment, it is assumed that a short-sized sheet S has a width smaller than A4 short edge feed (A4SEF) and a large-sized sheet S has a width larger than A4SEF.

Bases 44 having substantially elliptical shapes, which are examples of a retainer, are supported at both ends of each of the glass tubes 42 and 43. The bases 44 hold the ends of the glass tubes 42 and 42. Lead wires 46, which are examples of a connection cable, extend through the base 44 and are supported by the base 44. The lead wires 46 are electrically connected to the heater bodies 42a and 43a. The lead wires 46 are connected to the power supply E of the apparatus body U1, and electric power is supplied to the heater bodies 42a and 43a through the wires 46.

Referring to FIGS. 4 and 7, tips 42b and 43b are formed in the middle of the glass tubes 42 and 43 according to the first exemplary embodiment in the axial direction. The tips 42b and 43b, which are examples of a protruding portion, protrude outward from the outer surfaces of the glass tubes 42 and 43. Referring to FIG. 7, the tips 42b and 43b of the heater 41 according to the first exemplary embodiment protrude in opposite directions along the long axis of the base 44 having an substantially elliptic shape.

The tips 42b and 43b are the traces of the paths through which the glass tubes 42 and 43 were filled with the an inert gas such as nitrogen or argon, which is an example of a gas. The paths are sealed after the glass tubes 42 and 43 have been filled with the gas, and the tips 42b and 43b are formed as protruding portions. Referring to FIG. 7, the tips 42b and 43b according to the first exemplary embodiment are respectively disposed between the positions P4 and P6 and between the positions P3 and P5, which are located opposite each other with the second imaginary line 34 therebetween. That is, the tips 42b and 43b are respectively disposed in ranges A2 and A1, which are respectively a range between the positions P4 and P6 and a range between the positions P3 and P5 in the circumferential direction of the heating roller Fh around the rotation center of the heating roller Fh. In particular, in the first exemplary embodiment, the tips 42b and 43b are arranged in the long-axis direction of the heating roller Fh when the heating roller Fh is located at the pressurizing position in an elastically deformed state as illustrated in FIG. 7.

When the fixing device F according to the first exemplary embodiment performs a fixing operation to fix an image on the sheet S that passes through the fixing region Q5, a motion controller C1 of the controller C moves the eccentric cam 29 to the normal position by controlling the motor and holds the pressing belt Fp at the pressurizing position. On the basis of the temperature detected by the temperature sensor 31, a temperature controller C2 controls the heater and maintains the temperature of the fixing region Q5 at a predetermined fixing temperature.

When, for example, starting an image forming operation from a standby state, a so-called warm-up operation is performed to increase the temperature of the heating roller Fh of the fixing device F from the room temperature to the fixing temperature. In such a case, if the heating roller Fh and the pressing belt Fp contact each other in a large area as in the case where the pressing belt Fp is at the pressurizing position, heat is dissipated from the heating roller Fh to the pressing belt Fp, so that the heating roller Fh is not heated efficiently and the heating time increases. Therefore, when such heating of the heating roller Fh is performed, the motion controller C1 according to the first exemplary embodiment moves the eccentric cam 29 to the heating position and moves the pressing belt Fp to the depressurizing position, and thereby decreases the contact area between the heating roller Fh and the pressing belt Fp as illustrated by the alternate long and short dash line in FIG. 7. When the heating roller Fh is heated to a predetermined temperature, the motion controller C1 moves the pressing belt Fp to the pressurizing position so that a fixing operation may be performed.

According to the first exemplary embodiment, when an image forming operation is finished, the pressing belt Fp is moved to the depressurizing position, thereby preventing plastic deformation of the heating roller Fh, which may be caused by a pressure applied to the heating roller Fh during a standby state. However, the pressing belt Fp may be held at the pressurizing position in a standby state after an image forming operation is finished, instead of moving the pressing belt Fp to the depressurizing position when the image forming operation is finished.

### Operation of First Exemplary Embodiment

In the printer U according to the first exemplary embodiment having the structure described above, which is an example of an image forming apparatus, the pressing belt Fp is pressed against the base body 1, which is a thin-wall metal cylinder, and the base body 1 and the belt body 11 elastically deform in the fixing region Q5 as illustrated in FIG. 3. At this time, the heating roller Fh is elastically deformed in the sheet transport direction, and the contact area between the heating roller Fh and the pressing belt Fp increases, i.e., the fixing region Q5 is expanded, whereby the sheet S is stably transported and fixing is stably performed. As a result, for example, even when an envelope, which is an example of a medium, is used, the envelope is prevented from being creased. Moreover, when a thick sheet of paper, which is an example of a medium, is used, sufficient heat is supplied to the sheet and fixing failure is reduced.

When the base body 1 rotates and a part of the base body 1 that has been elastically deformed in the fixing region Q5 is separated from the fixing region Q5, the elastically deformed part recovers to its original cylindrical shape. The base body 1 according to the first exemplary embodiment does not include a member that contacts the inner surface of the cylindrical inner surface thereof in the fixing region Q5. Nevertheless, when the base body 1 is rotated and passes the fixing region Q5 at which the base body 1 contacts the sheet S, the base body 1 is elastically deformed, thereby applying a pressure to the sheet S, increasing the contact area between the base body 1, and applying heat to the sheet S. Moreover, the base body 1 elastically recovers to its original shape when the base body 1 is rotated further and passes the fixing region Q5.

The fixing device F according to the first exemplary embodiment need not include a member that presses the base body 1 from the inside in the fixing region Q5 and thereby deforms the base body 1 into a predetermined shape. Therefore, as compared with existing technologies, increase in the number of members, increase in the thermal capacity due to the increased number of members, and increase in the power consumption due to the increased thermal capacity are prevented. That is, as compared with the case where the fixing device F includes another member having a thermal capacity and heating is performed through the other member, heating is efficiently performed by the heater 41.

Therefore, because heating is efficiently performed by the heater 41 in the fixing device F, inefficient consumption of heat and electric power is reduced, the fixing region Q5 is efficiently and rapidly heated, and thereby a time required for preheating before starting a fixing operation is reduced.

When the fixing device F according to the first exemplary embodiment is in a standby state or warming up the heating roller Fh, the pressing belt Fp is at the depressurizing position, so that the contact area between the heating roller Fh and the pressing belt Fp is smaller than that when the pressing belt Fp is at the pressurizing position. Therefore, the heating efficiency is increased, and the time required for preheating before stating a fixing operation is further reduced.

In existing fixing devices, a press fixing member, such as the pressing belt Fp or a pressing roller, generally remains in contact with the heating roller Fh after an image forming operation has been finished. The heating roller Fh and the pressing roller Fp are generally in contact with each other in a normal state excluding a maintenance time such as when a sheet is jammed and a user opens the cover U2 and manually releases the contact. Therefore, a temperature sensor and a temperature fuse are disposed at positions corresponding to the surface of the heating roller Fh that is elastically deformed by being pressed against the pressing roller Fp, because the temperature sensor and the temperature fuse are assumed to detect the temperature and the like of the heating roller Fh that is in contact with the pressing belt Fp. That is, it is assumed that the distances between the surface of the heating roller Fh and the temperature sensor and the like do not change while the temperature sensor operates.

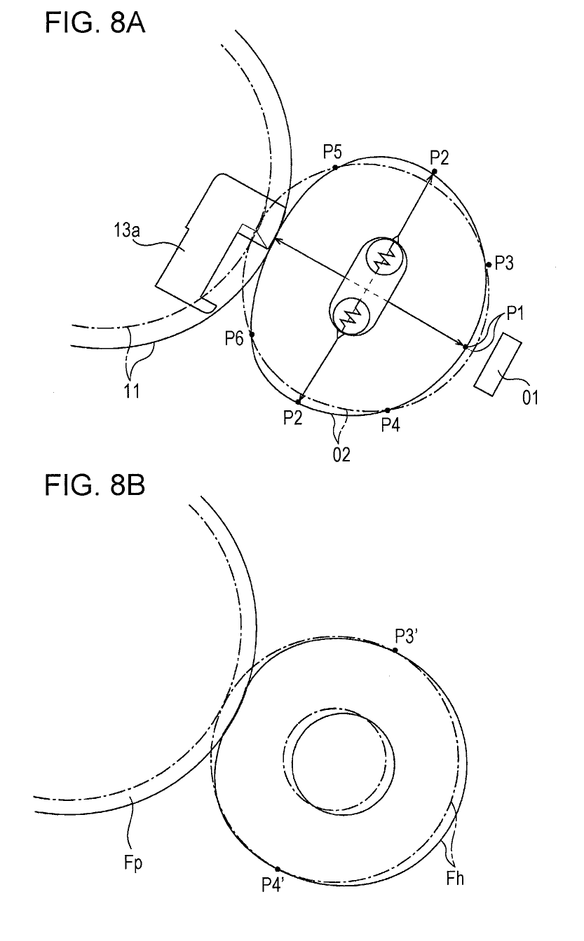

FIGS. 8A and 8B illustrate a known structure, FIG. 8A illustrating a case where a heating roller that is a thin-wall cylinder is used and a temperature sensor is disposed on a side of the heating roller opposite to a fixing region, and FIG. 8B illustrating a case where a heating roller that is a thick-wall cylinder is used.

In the case of the first exemplary embodiment, the pressing belt Fp is moved to the depressurizing position when heating the heating roller Fh and moved to the pressurizing position after the heating roller Fh has been heated and before a fixing operation is started. Accordingly, as illustrated by solid line and alternate long and short dash line in FIG. 7, the amount of elastic deformation of the pressing roller Fh differs and the shape of the surface of the heating roller Fh differs between the time when the heating roller is being heated and the time when the heating roller has been heated. Therefore, for example, if a temperature sensor 01 or a temperature fuse is disposed at the position P1 or the position P2 illustrated in FIG. 8A, the distance between the temperature sensor 01 and the heating roller 02 differs between the time before the fixing operation is started and the time during which an image forming operation is performed. Thus, if the temperature sensor 01 or the like is disposed at the positions P1 or P2, the accuracy of the temperature measured by the temperature sensor 01 may decrease, which may cause a problem such as a fixing failure due to insufficient heating, overheating, generation of smoke or fire, or malfunctioning of a temperature fuse.

In contrast, in the first exemplary embodiment, the temperature sensor 31 and the temperature fuse are disposed at the position P3. Therefore, even when the pressing belt Fp moves between the depressurizing position and the pressurizing position, variation in the distance between the surface of the heating roller Fh and the temperature sensor 31 is small. Thus, reduction in the accuracy of measuring the temperature performed by the temperature sensor 31 is prevented, so that occurrence of insufficient heating, overheating, or malfunctioning of the temperature fuse is reduced.

The fixing device F according to the first exemplary embodiment uses the base body 1, which has a thin-wall cylindrical shape, as the heating roller Fh. As illustrated in FIG. 7, when the pressing belt Fp is moved to the pressurizing position, the base body 1 is deformed into a substantially elliptical shape such that that distance between fixing region Q5 and the position P1 on the opposite side of the fixing region Q5 decreases. Therefore, the four positions P3 to P6 on the surface of the heating roller Fh do not change before and after the pressing belt Fp is moved, and the temperature sensor 31 may be disposed at any of the four positions P3 to P6. Referring to FIG. 8B, in the case where the exiting base body having a thick-wall cylindrical shape is used, when the pressing belt Fp is moved to the pressurizing position, the heating roller Fh is deformed such that the distance between the fixing region Q5 and the position P1 opposite to the fixing region Q5 increases. Therefore, only two positions P3′ and P4′ on the surface of the heating roller Fh do not change. As a result, with the fixing device F according to the first exemplary embodiment, which uses a thin-wall cylinder is used as the base body 1, the number of positions at which the temperature sensor 31 may be disposed is larger than that of the case where a thick-wall cylinder is used as the base body 1, whereby flexibility in the design is increased.

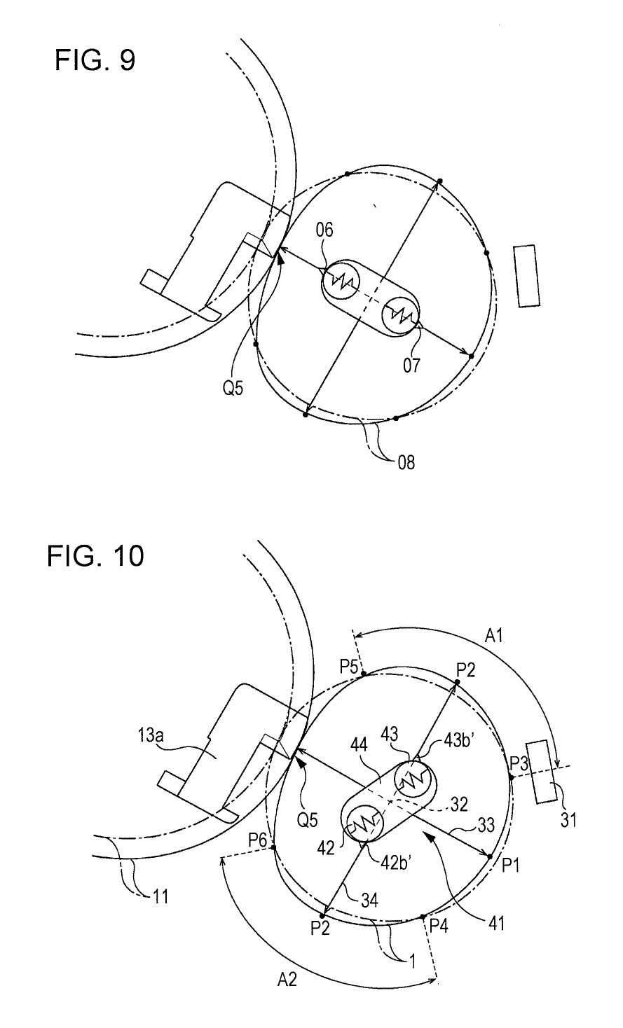

FIG. 9 illustrates an operation of the first exemplary embodiment when the tips are arranged along the short axis.

Referring to FIG. 7, in the fixing device F according to the first exemplary embodiment, the tips 42b and 43b of the heater 41 are arranged in the long-axis direction of the heating roller Fh that is elastically deformed. When the tips 06 and 07 are arranged in the short-axis direction as illustrated in FIG. 9, the distances between the tips 06 and 07 and the inner surface of the elastically deformed heating roller 08 are small. In this case, if an unexpectedly thick medium, such as a stack of two or more sheets, enters the fixing region Q5, the heating roller 08 becomes elastically deformed to a large extent and the inner surface of the heating roller 08 may contact the tips 06 and 07, so that the inner surface of the heating roller 08 may be damaged and the temperature of the heating roller 08 may become nonuniform. In particular, if the heating roller 08 contacts the ends of tips 06 and 07, which are pointed, the heating roller 08 that has a thin-wall cylindrical shape may be broken.

In contrast, in the first exemplary embodiment, the tips 42b and 43b of the heater 41 are arranged in the long-axis direction of the elastically deformed heating roller Fh. Therefore, even if an unexpectedly thick medium enters the fixing region Q5, the inner surface of the heating roller Fh is not likely to contact the tips 42b and 43b. Thus, as compared with the case where the tips are arranged in the short-axis direction, breakage of the heating roller Fh is reduced.

### Second Embodiment

Next, a second exemplary embodiment of the present invention will be described. In the description of the second exemplary embodiment, the elements corresponding to those of the first exemplary embodiment will be denoted by the same numerals and detailed description thereof will be omitted.

The second exemplary embodiment is different from the first exemplary embodiment in the following respects and is the same as the first exemplary embodiment in other respects.

FIG. 10 is a partial enlarged view of a fixing device according to the second exemplary embodiment, which corresponds to FIG. 7 for the first exemplary embodiment.

Referring to FIG. 10, the heater 41 of the fixing device F according to the second exemplary embodiment differs from the heater 41 according to the first exemplary embodiment in that tips 42b′ and 43b′ protrude in opposite directions that intersect the long-axis direction of the base 44 having a substantially elliptic shape. The tips 42b′ and 43b′ are arranged at positions that are substantially point-symmetric about the center of the heater 41.

Also in the second exemplary embodiment, ends of the tips 42b′ and 43b′ of the heater 41 are arranged in the long-axis direction of the elastically deformed heating roller Fh. That is, the tips 42b′ and 43b′ are respectively disposed in the ranges A2 and A1, which are respectively a range between the positions P4 and P6 and a range between the positions P3 and P5 around the rotation center of the heating roller Fh.

### Operation of Second Exemplary Embodiment

With the fixing device F according to the second exemplary embodiment having the structure described above, as with the first exemplary embodiment, even if an unexpectedly thick medium enters the fixing region Q5 and the heating roller Fh is deformed to a large extent, the heating roller Fh is not likely to contact the tips 42b′ and 43b′, whereby breakage or rupture of the heating roller Fh is reduced.

### Modification

The present invention is not limited to the exemplary embodiments described above, and the exemplary embodiments may be modified in various ways within the spirit and scope of the present invention described in the claims. Modifications (H01) to (H011) of the exemplary embodiments of the present invention will be described.

(H01) In the exemplary embodiments described above, the printer U is used as an example of an image forming apparatus. However, the image forming apparatus is not limited thereto, and may be a copier, facsimile, or a multifunctional device having the functions of such machines. The image forming apparatus is not limited to a multi-color image forming apparatus, and may be a single-color image forming apparatus. The image forming apparatus is not limited to an apparatus using the transfer/transport belt B, and may be an existing apparatus that uses an intermediate transfer body.
(H02) In the exemplary embodiments described above, the heating roller Fh including the two heater bodies 42a and 43a is used. However, this is not limited thereto, and the number of heater bodies may be one or large than two. The range that is heated by the heater bodies 42a and 43a is not limited to that of the exemplary embodiment, and any appropriate range used in existing technologies may be used.
(H03) In the exemplary embodiments described above, the temperature sensor 31 and the temperature fuse are disposed at the same position P3 with respect to the circumferential direction of the heating roller Fh. However, this is not limited thereto, and the temperature sensor 31 and the temperature fuse may be disposed at any of the positions P3 to P6 that are different from each other. Plural temperature sensors 31 and temperature fuses may be arranged in the axial direction of the heating roller Fh. In this case, the temperature sensors 31 may arranged at any of the positions P3 to P6 that are different from each other.
(H04) In the exemplary embodiments described above, the tips 42b, 43b, 42b′, and 43b′ are disposed at positions in the middle of the heater 41 in the axial direction. However, this is not limited thereto, and the tips may be disposed at any appropriate positions depending on the manufacturing process, the design, and the specifications.
(H05) In the exemplary embodiments described above, the pressing belt Fp is used. However, this is not limited thereto, and any appropriate existing pressing roller may be used.
(H06) In the exemplary embodiment described above, a thin-wall cylinder is used as the heating roller Fh. However, this is not limited thereto, and a thick-wall cylinder may be used as the heating roller Fh.
(H07) In the exemplary embodiments described above, the heating roller Fh is fixed in place and the pressing belt Fp is moved closer to and away from the heating roller Fh. However, this is not limited thereto, and the heating roller Fh may be moved or both the heating roller Fh and the pressing belt Fp may be moved. In the exemplary embodiments described above, the eccentric cam 29 and the press spring 28 are used as the mechanism for moving the pressing belt Fp between the pressurizing position and the depressurizing position. However, this is not limited thereto, and any mechanism that is capable of moving the heating roller Fh and the pressing belt Fp between the two positions may be used. For example, a combination of a solenoid and a spring may be used, or the heating roller Fh may be pressed by using an eccentric cam alone and without using a spring. In this case, the heating roller Fh may be returned to the depressurizing position by using an elastic recovery force of the heating roller.
(H08) In the exemplary embodiments described above, the pressing belt Fp may be configured to be moved to the depressurizing position after an image forming operation has been finished or during a warm-up operation. However, the pressing belt Fp may be held at the pressurizing position. That is, the pressing belt Fh may be moved to the pressurizing position when performing an image forming operation, in a standby state, or during a warm-up operation; and the pressing belt Fp may be moved to the depressurizing position by a user when the user removes a jammed sheet. Also with this structure, it may happen that the next image forming operation is started in a state in which the user forgot to return the pressing roller Fh from the depressurizing position to the pressurizing position after removing the jammed sheet. In such a case, by using the temperature sensor 31 according to the exemplary embodiments, even if heating of the heater 41 is started at the depressurizing position that is different from the normal pressurizing position, the fixing temperature is accurately detected and occurrence of a fault due to overheating is reduced. Therefore, the contact moving member is not limited to the eccentric cam 29 that is driven by the motor M1, and a lever or the like that is manually operated by a user may be used.
(H09) The material, the size, the length, and other values used in the exemplary embodiment may be appropriately changed in accordance with the design, the specifications, and the like.
(H010) In the exemplary embodiments described above, the heating roller Fh and the pressing belt Fp contact each other at the depressurizing position. However, this is not limited thereto, and the heating roller Fh and the pressing belt Fp may be separated from each other at the depressurizing position.
(H011) In the exemplary embodiments described above, the temperature sensor 31 is disposed at one of the positions P3 to P6. However, the temperature sensor 31 may be disposed at a position that is displaced from the one of the positions P3 to P6 in the circumferential direction within the tolerance of accuracy of detecting the temperature.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device that fixes an unfixed image transferred to a surface of a medium, the fixing device comprising:
a heat fixing member that is supported so as to be rotatable and contactable with the surface of the medium, the heat fixing member being heated by a heater, the heat fixing member including
a base body that is elastically deformable and that has a cylindrical shape extending in a medium width direction that intersects a transport direction of the medium, the base body applying pressure to the medium and increasing a contact area between the base body and the medium by being elastically deformed without using a member that is disposed so as to contact an inner surface of the cylindrical shape in a fixing region, and applying heat to the medium when the base body is rotated and passes the fixing region, the fixing region being a region in which the base body contacts the medium, the base body elastically recovering to the cylindrical shape when the base body has passed the fixing region after being rotated;
a press fixing member that is disposed so as to face the heat fixing member and that is supported so as to be rotatable, the press fixing member applying pressure to the medium that is nipped between the press fixing member and the heat fixing member;
a contact moving member that moves at least one of the heat fixing member and the press fixing member between a pressurizing position and a depressurizing position, the pressurizing position being a position at which the heat fixing member and the press fixing member contact each other with a predetermined contact pressure in the fixing region in which the heat fixing member and the press fixing member contact each other, the depressurizing position being a position at which the heat fixing member and the press fixing member are separated from each other as compared with the pressurizing position and pressure in the fixing region is reduced from the predetermined contact pressure;
a temperature detector that detects a temperature of the heat fixing member, the temperature detector being disposed so as to face a middle position between a first position and a second position in a circumferential direction of the heat fixing member, the first position being an intersection of an extension line of a first imaginary line and an outer surface of the heat fixing member, the first imaginary line being a line connecting a center of the fixing region and a rotation center of the heat fixing member, the fixing region being a region in which the heat fixing member and the press fixing member contact each other, the second position being an intersection of a second imaginary line and the outer surface of the heat fixing member, the second imaginary line being a line that passes through the rotation center of the heat fixing member and that is perpendicular to the first imaginary line; and
a temperature controller that controls operation of the heater on the basis of a detection result obtained by the temperature detector and thereby controls a temperature of the heat fixing member.

2. The fixing device according to claim 1, further comprising:
the heater including
a heater container that is cylindrical, is disposed in the heat fixing member, and extends in a width direction that intersects the transport direction of the medium,
a heater body that is contained in the heater container and generates heat when energized, and
a protruding portion that is formed so as to allow a gas to pass therethrough to fill the heater container with the gas and that is sealed subsequently, the protruding portion protruding outward from an outer surface of the heater container, the protruding portion being disposed so as to correspond to a plurality of the middle positions that are adjacent to each other with the second imaginary line therebetween.

3. A fixing device that fixes an unfixed image transferred to a surface of a medium, the fixing device comprising:
a heat fixing member that is supported so as to be rotatable and contactable with the surface of the medium, the heat fixing member being heated by a heater, the heat fixing member including
a base body that is elastically deformable and that has a cylindrical shape extending in a medium width direction that intersects a transport direction of the medium, the base body applying pressure to the medium and increasing a contact area between the base body and the medium by being elastically deformed without using a member that is disposed so as to contact an inner surface of the cylindrical shape in a fixing region, and applying heat to the medium when the base body is rotated and passes the fixing region, the fixing region being a region in which the base body contacts the medium, the base body elastically recovering to the cylindrical shape when the base body has passed the fixing region after being rotated;
a press fixing member that is disposed so as to face the heat fixing member and that is supported so as to be rotatable, the press fixing member applying pressure to the medium that is nipped between the press fixing member and the heat fixing member;
a contact moving member that moves at least one of the heat fixing member and the press fixing member between a pressurizing position and a depressurizing position, the pressurizing position being a position at which the heat fixing member and the press fixing member contact each other with a predetermined contact pressure in the fixing region in which the heat fixing member and the press fixing member contact each other, the depressurizing position being a position at which the heat fixing member and the press fixing member are separated from each other as compared with the pressurizing position and pressure in the fixing region is reduced from the predetermined contact pressure;
a temperature detector that detects a temperature of the heat fixing member, the temperature detector being disposed at a position corresponding to an intersection of an outer surface of the heat fixing member when the heat fixing member is at the depressurizing position and the outer surface of the heat fixing member when the heat fixing member is at the pressurizing position and the heat fixing member is elastically deformed as compared with a state in which the heat fixing member is at the depressurizing position; and
a temperature controller that controls operation of the heater on the basis of a detection result obtained by the temperature detector and thereby controls a temperature of the heat fixing member.

4. The fixing device according to claim 3, further comprising:
the heater including
a heater container that is cylindrical, is disposed in the heat fixing member, and extends in a width direction that intersects the transport direction of the medium,
a heater body that is contained in the heater container in a sealed state and generates heat when energized, and
a protruding portion that is formed so as to allow a gas to pass therethrough to fill the heater container with the gas and that is sealed subsequently, the protruding portion protruding outward from an outer surface of the heater container, the protruding portion being disposed so as to correspond to a long-axis direction of the heat fixing member that is at the pressurizing position and that is elastically deformed.

5. The fixing device according to claim 1, further comprising:
a motion controller that controls the contact moving member, the motion controller moving the heat fixing member and the press fixing member to the depressurizing position when increasing the temperature of the heat fixing member to a predetermined fixing temperature before a fixing operation is started, the motion controller moving the heat fixing member and the press fixing member to the pressurizing position when the fixing operation is started.

6. The fixing device according to claim 2, further comprising:
a motion controller that controls the contact moving member, the motion controller moving the heat fixing member and the press fixing member to the depressurizing position when increasing the temperature of the heat fixing member to a predetermined fixing temperature before a fixing operation is started, the motion controller moving the heat fixing member and the press fixing member to the pressurizing position when the fixing operation is started.

7. The fixing device according to claim 3, further comprising:
a motion controller that controls the contact moving member, the motion controller moving the heat fixing member and the press fixing member to the depressurizing position when increasing the temperature of the heat fixing member to a predetermined fixing temperature before a fixing operation is started, the motion controller moving the heat fixing member and the press fixing member to the pressurizing position when the fixing operation is started.

8. The fixing device according to claim 4, further comprising:
a motion controller that controls the contact moving member, the motion controller moving the heat fixing member and the press fixing member to the depressurizing position when increasing the temperature of the heat fixing member to a predetermined fixing temperature before a fixing operation is started, the motion controller moving the heat fixing member and the press fixing member to the pressurizing position when the fixing operation is started.

9. An image forming apparatus comprising:
an image carrier that rotates;
a developing device that develops a latent image formed on a surface of the image carrier into a visible image;
a transfer device that transfers the visible image from the surface of the image carrier to a medium; and
the fixing device according to claim 1, the fixing device fixing the visible image on the medium.

10. An image forming apparatus comprising:
an image carrier that rotates;
a developing device that develops a latent image formed on a surface of the image carrier into a visible image;
a transfer device that transfers the visible image from the surface of the image carrier to a medium; and
the fixing device according to claim 2, the fixing device fixing the visible image on the medium.

11. An image forming apparatus comprising:
an image carrier that rotates;
a developing device that develops a latent image formed on a surface of the image carrier into a visible image;
a transfer device that transfers the visible image from the surface of the image carrier to a medium; and
the fixing device according to claim 3, the fixing device fixing the visible image on the medium.

12. An image forming apparatus comprising:
an image carrier that rotates;
a developing device that develops a latent image formed on a surface of the image carrier into a visible image;
a transfer device that transfers the visible image from the surface of the image carrier to a medium; and
the fixing device according to claim 4, the fixing device fixing the visible image on the medium.

13. An image forming apparatus comprising:
an image carrier that rotates;
a developing device that develops a latent image formed on a surface of the image carrier into a visible image;
a transfer device that transfers the visible image from the surface of the image carrier to a medium; and
the fixing device according to claim 5, the fixing device fixing the visible image on the medium.

14. An image forming apparatus comprising:
an image carrier that rotates;
a developing device that develops a latent image formed on a surface of the image carrier into a visible image;
a transfer device that transfers the visible image from the surface of the image carrier to a medium; and
the fixing device according to claim 6, the fixing device fixing the visible image on the medium.

15. An image forming apparatus comprising:
an image carrier that rotates;
a developing device that develops a latent image formed on a surface of the image carrier into a visible image;
a transfer device that transfers the visible image from the surface of the image carrier to a medium; and
the fixing device according to claim 7, the fixing device fixing the visible image on the medium.

16. An image forming apparatus comprising:
an image carrier that rotates;
a developing device that develops a latent image formed on a surface of the image carrier into a visible image;
a transfer device that transfers the visible image from the surface of the image carrier to a medium; and
the fixing device according to claim 8, the fixing device fixing the visible image on the medium.
